(19) United States
(12) Patent Application Publication
(10) Pub. No.: US 2018/0262386 A1
(43) Pub. Date: Sep. 13, 2018

(54) COMMUNICATION APPARATUS, COMMUNICATION METHOD, AND PROGRAM

(71) Applicant: HONDA MOTOR CO., LTD., Tokyo (JP)

(72) Inventors: Kazuyoshi Wakita, Wako-shi (JP); Michitaka Tsuboi, Wako-shi (JP); Shoichi Ito, Wako-shi (JP)

(21) Appl. No.: 15/916,456

(22) Filed: Mar. 9, 2018

(30) Foreign Application Priority Data
Mar. 13, 2017 (JP) 2017-047828

(51) Int. Cl. H04L 12/24

(52) U.S. Cl. CPC H04L 41/0622; H04L 41/069; H04L 41/0609

(57) ABSTRACT

A communication apparatus of an embodiment includes: a communication unit connected to a communication path; and an abnormality detection section that detects an abnormality in a network based on a number of predetermined signals received in a first predetermined period via the communication unit and waits for a process of detecting the abnormality in the network in a second predetermined period after a start of a communication in the network.

### CROSS-REFERENCE TO RELATED APPLICATION

Priority is claimed on Japanese Patent Application No. 2017-047828, filed on Mar. 13, 2017, the contents of which are incorporated herein by reference.

### BACKGROUND

### Field of the Invention

The present invention relates to a communication apparatus, a communication method, and a program.

### Background

In the related art, there has been disclosed a network monitoring device including a determination unit that monitors a communication message selected on the basis of message IDs of communication messages flowing through a network, determines that an abnormality occurs in a communication state of the monitored communication message when a reception interval of the monitored communication message is shorter than an appropriate reception interval specified as a range including a transmission interval of the communication message and determines that the abnormality occurs in a communication state of another communication message, other than the monitored communication message, when the reception interval of the monitored communication message is longer than the appropriate reception interval (for example, see Japanese Unexamined Patent Application, First Publication No. 2014-187445).

### SUMMARY

However, there are cases where the aforementioned device erroneously determines an abnormality in a communication state.

An object of an aspect of the present invention is to provide a communication apparatus, a communication method, and a program, by which it is possible to accurately determine an abnormality in a communication state.

(1) A communication apparatus according to an aspect of the present invention includes: a communication unit connected to a communication path; and an abnormality detection section that detects an abnormality in a network based on a number of predetermined signals received in a first predetermined period via the communication unit and waits for a process of detecting the abnormality in the network in a second predetermined period after a start of a communication in the network.

(2) In the aforementioned communication apparatus, the second predetermined period may include a period after a return from a state in which a signal is not receivable from the network.

(3) In the aforementioned communication apparatus, the second predetermined period may include a period after a return from a state in which a signal is not transmittable to the network.

(4) The aforementioned communication apparatus may further include a storage area that stores a signal to be transmitted, and the second predetermined period may include a period after a start of a communication when the communication starts in a state in which a signal exceeding a predetermined amount is stored in the storage area.

(5) In the aforementioned communication apparatus, the second predetermined period may include a period after an ignition is controlled from an OFF state to an ON state.

(6) In the aforementioned communication apparatus, the second predetermined period may be a period until the abnormality detection section receives the predetermined signal and then receives the predetermined signal when a predetermined cycle elapses.

(7) The aforementioned communication apparatus may further include an information storage unit that stores identification information allocated to the communication apparatus, and the second predetermined period may be set as a period until the abnormality detection section receives all signals with the identification information allocated to the communication apparatus and stored in the information storage unit.

(8) The aforementioned communication apparatus may further include an information storage unit that stores identification information having a lowest priority among identification information allocated to the communication apparatus, and the second predetermined period may be set as a period until the abnormality detection section receives a signal with the identification information having the lowest priority among the identification information allocated to the communication apparatus.

(9) In the aforementioned communication apparatus, the second predetermined period may be a period until, in a case where the communication apparatus transmits a signal to another communication apparatus, a response signal serving as a response from the other communication apparatus to the signal is received in the communication apparatus.

(10) Another aspect of the present invention is a communication apparatus including: a communication unit configured to be connected to a communication path; and an abnormality detection section configured to determine that an abnormality exists in a communication state when a signal is received at a timing different from a reception cycle set in advance for a signal received via the communication unit, wherein after the communication apparatus starts a communication in a network and a first signal is received, when the first signal is received again before a reception cycle set in advance for the first signal elapses, the abnormality detection section excludes the first signal received again from an object determined as an abnormality in the communication state.

(11) Further another aspect of the present invention is a communication method by way of a computer installed at a vehicle, the method including: detecting an abnormality in a network based on a number of predetermined signals received in a first predetermined period; and waiting for a process of detecting the abnormality in the network in a second predetermined period after a start of a communication in the network.

(12) Further another aspect of the present invention is a computer readable non-transitory recording medium including a program causing a computer installed at a vehicle to perform: detecting an abnormality in a network based on a number of predetermined signals received in a first predetermined period; and waiting for a process of detecting the abnormality in the network in a second predetermined period after a start of a communication in the network.

According to the aforementioned configurations of (1) to (12), it is possible to accurately determine an abnormality in a communication state.

### BRIEF DESCRIPTION OF THE DRAWINGS

FIG. 1 is a diagram illustrating a configuration of a communication system.

FIG. 2 is a diagram illustrating a functional configuration of an ECU.

FIG. 3 is a sequence diagram illustrating a process performed by the communication system.

FIG. 4 is a flowchart illustrating a flow of a process performed by a communication control section of the ECU.

FIG. 5 is a conceptual diagram of a process of the communication system.

### DESCRIPTION OF THE EMBODIMENTS

Hereinafter, an embodiment of a communication apparatus, a communication method, and a program of the present invention will be described with reference to the drawings.

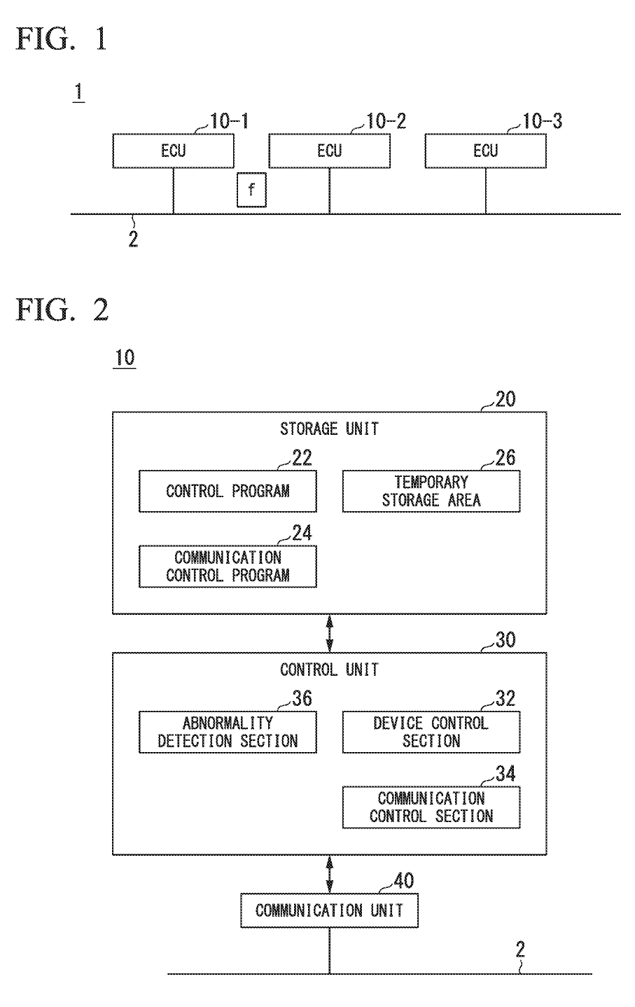

FIG. 1 is a diagram illustrating a configuration of a communication system 1. The communication system 1, for example, is installed at a vehicle and configures a network in the vehicle. The communication system 1 includes ECUs 10-1 to 10-3 connected to a communication path 2. Hereinafter, when the ECUs 10-1 to 10-3 are not distinguished from one another, they are simply referred to an ECU 10 (a communication apparatus). The number of the ECUs 10 is not limited to three and may be one, two, or four or more.

In the communication system 1, for example, communication based on a communication scheme such as a controller area network (CAN) protocol and an IEEE 802.3 is performed via the communication path 2.

The ECU 10, for example, includes an engine ECU for controlling an engine, a seat belt ECU for controlling a seat belt, and the like. The ECU 10 receives frames transmitted to the network of the communication system 1. Hereinafter, frames (signals) transmitted to the network will be referred to as frames f. An identifier (hereinafter, referred to as an ID) is assigned to each of the frames f. A storage unit of the ECU 10 stores information on an identifier (hereinafter, referred to as a registered ID) employed as an object to be processed by the ECU 10 (allocated to the ECU 10). When the frames f are received, the ECU 10 refers to IDs assigned to the received frames f, extracts and acquires a frame f with the same ID as the registered ID, and does not acquire a frame f with an ID different from the registered ID serving as a frame f other than the object to be processed.

FIG. 2 is a diagram illustrating a functional configuration of the ECU 10. The ECU 10, for example, includes a storage unit 20 (an information storage unit), a control unit 30, and a communication unit 40. The control unit 30, for example, is implemented when a processor such as a central processing unit (CPU) executes a program stored in the storage unit 20. Furthermore, the control unit 30 may be implemented by hardware such as a large scale integration (LSI), an application specific integrated circuit (ASIC), and a field programmable gate array (FPGA), and may have a circuit configuration for performing functions of the control unit 30. Furthermore, the control unit 30 may also be implemented by software and hardware in cooperation.

The storage unit 20, for example, is implemented by a nonvolatile storage device such as a read only memory (ROM), an electrically erasable and programmable read only memory (EEPROM), and a hard disk drive (HDD) and a volatile storage device such as a random access memory (RAM) and a register. The storage unit 20 stores a control program 22, a communication control program 24 and the like. Furthermore, the storage unit 20 has a temporary storage area 26 (a storage area) including a transmission buffer (not illustrated) and a reception buffer (not illustrated). Furthermore, the storage unit 20 stores information on a frame f to be transmitted by the ECU 10, information on a frame f to be received, information on a reception cycle of the frame f to be received, and the like.

The control program 22 is a program for controlling a device and the like allocated to the ECU 10. The communication control program 24 is a program for controlling communication of the ECU 10.

The control unit 30 includes a device control section 32, a communication control section 34, and an abnormality detection section 36. The device control section 32 is implemented by executing the control program 22 and performs control allocated to the ECU 10.

The communication control section 34 is implemented by executing the communication control program 24 and controls the communication of the ECU 10. The communication control section 34 acquires information included in a frame f to be processed and stores the information in the temporary storage area 26 of the storage unit 20. The communication control section 34 allows the communication unit 40 to transmit the frames f on the basis of information input to the ECU 10, the acquired information included in the frame f, the communication control program 24 and the like.

The abnormality detection section 36 is implemented by executing the communication control program 24 and detects abnormality of a communication state of the ECU 10. The abnormality detection section 36 detects abnormality of a network on the basis of the number of predetermined frames f (signals) received in a first predetermined period via the communication unit 40, and waits for a process of detecting the abnormality of the network in a second predetermined period after the start of communication in the network of the communication system 1. The predetermined frames f, for example, are frames f that are objects to be received in the ECU 10 of a reception side and are abnormality detection objects. Details of the process of the abnormality detection section 36 will be described later. The communication unit 40 communicates with another apparatus under the control of the communication control section 34.

A format example of a frame f transmitted from the ECU 10 to the communication path 2 will be described. A frame f transmitted in one-time transmission, for example, includes a start of frame D (SOF) indicating the start of the frame f, an ID serving as an identifier of the frame f, a remote transmission request (RTR) for identifying the frame f and a remote frame (a frame obtained by removing a frame field from the frame f), a control field indicating the number of bytes and the like of the frame f, a frame field serving as the entity of the frame f to be transmitted, a CRC sequence applying a CRC for checking an error of the frame f, an ACK slot and an ACK delimiter receiving a notification (an ACK notification) from a unit (for example, an ECU) having received a correct message, an end-of-frame (EOF) indicating the end of the frame f, and the like.

In the communication path 2, communication arbitration based on a priority indicated by the ID and the RTR is performed. The priority is high in a frame f having a small ID value. When frames f are simultaneously transmitted from a plurality of ECUs 10, the ECUs 10 compare the frames f transmitted by themselves with a monitoring result of the state of the communication path 2. When a recessive and a dominant are simultaneously transmitted from separate ECUs 10, the dominant takes a priority and the state of the communication path 2 becomes dominant In this case, the ECU 10 having transmitted the recessive determines communication arbitration failure due to the recessive transmitted by the ECU 10 and the state of the communication path 2 being different from each other, and stops the transmission of the frame f. In this way, in a case where the other ECU 10 transmits a dominant when the transmission of the frames f is simultaneously started from the plurality of ECUs 10 and one ECU 10 performs recessive transmission, the ECU 10 having transmitted the dominant corresponding to a frame f having a small ID value succeeds in communication arbitration.

[Process of Communication System]

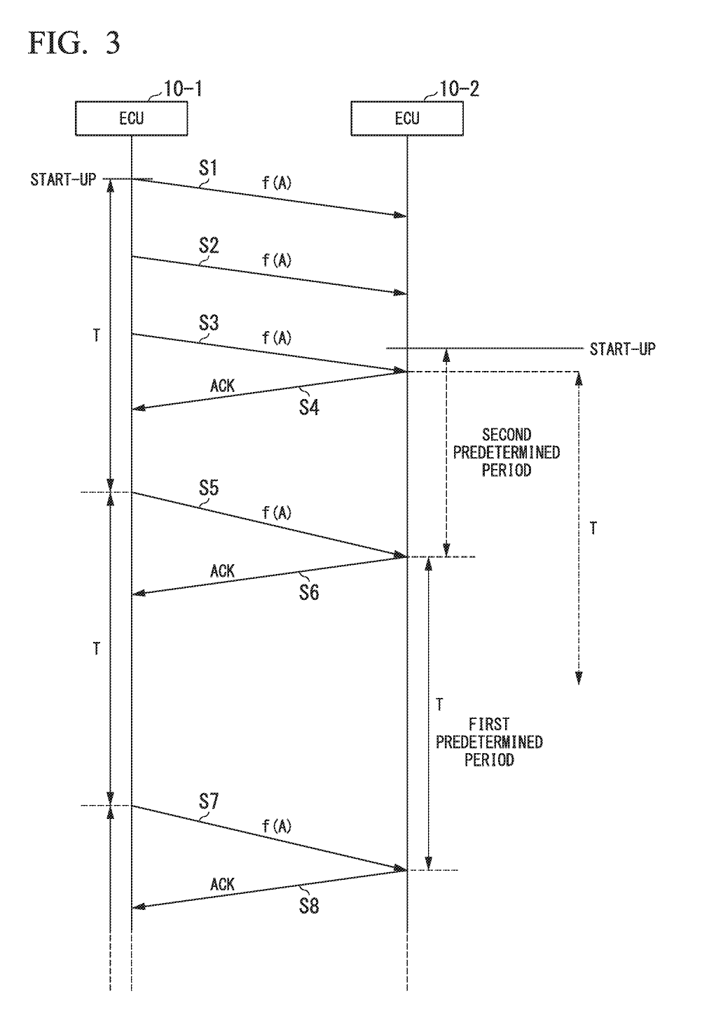

FIG. 3 is a sequence diagram illustrating the process performed by the communication system 1. The present process will describe, as an example, a process when the ECU 10-1 transmits a frame f (A) including an ID “A” to the ECU 10-2. Furthermore, the present process is a process which is performed after the ECU 10-1 starts to operate. For example, the present process is a process which is started after an ignition switch of a vehicle installed with the communication system 1 is controlled from an OFF state to an ON state. Furthermore, the ignition switch is controlled from the OFF state to the ON state, so that the ECU 10-1 starts to operate. The following description will be given on the assumption that the ECU 10-1 starts to operate and then the ECU 10-2 starts to operate after a predetermined time passes (immediately before the frame f (A) transmitted in step S3 to be described later reaches the ECU 10-2).

Furthermore, it is assumed that information on a transmission cycle T of the frame f (A) is stored in the storage unit 20 of the ECU 10-2.

Furthermore, it is assumed that the ECU 10-1 transmits the frame f (A) to the ECU 10-2 every cycle T, and when it is not possible to confirm that the ECU 10-2 receives the frame f (A) in a predetermined time after the frame f (A) is transmitted, the ECU 10-1 transmits the frame f (A) to the ECU 10-2 before the passage of the cycle T.

Firstly, the ECU 10-1 starts to operate and then transmits the frame f (A) to the ECU 10-2 (step S1). In this case, since the ECU 10-2 does not start to operate, the ECU 10-1 does not receive an ACK notification. Therefore, after a predetermined time passes from the transmission of the frame f (A) in step S1, the ECU 10-1 transmits the frame f (A) to the ECU 10-2 again (step S2). Similarly to the above, in this case, since the ECU 10-2 does not start to operate, the ECU 10-1 does not accept an ACK notification.

After the frame f (A) is transmitted in step S2 and a predetermined time passes, the ECU 10-1 transmits the frame f (A) to the ECU 10-2 again (step S3). In this case, since the ECU 10-2 starts to operate, the ECU 10-2 transmits, to the ECU 10-1, an ACK notification indicating the reception of the frame f (A) transmitted from the ECU 10-1 (step S4). The ECU 10-1 receives the ACK notification transmitted from the ECU 10-2, thereby recognizing that the frame f (A) has been transmitted to the ECU 10-2.

When the frame f (A) is initially transmitted after the start-up and then the cycle T passes, the ECU 10-1 transmits the frame f (A) (step S5). The ECU 10-2 receives the frame f (A) transmitted from the ECU 10-1 and transmits, to the ECU 10-1, an ACK notification indicating the reception of the frame f (A) (step S6).

Next, when the frame f (A) is transmitted in step S5 and then the cycle T passes, the ECU 10-1 transmits the frame f (A) to the ECU 10-2 (step S7). The ECU 10-2 receives the frame f (A) transmitted from the ECU 10-1 and transmits, to the ECU 10-1, an ACK notification indicating the reception of the frame f (A) (step S8).

For example, when an ECU to be compared starts to operate, receives the frame f (A) transmitted in step S3, and then receives the frame f (A) (transmitted in step S5 for example) before the cycle T passes, the ECU detects abnormality of a communication state.

In contrast, after the ECU 10-2 of the present embodiment starts to operate, even though the ECU 10-2 receives the frame f (A) again before the cycle T passes from the reception of the frame f (A), the ECU 10-2 does not determine abnormality of a communication state. That is, when the frame f (A) received again is received and then the frame f (A) is received before the cycle T passes (between step S5 and step S7), the ECU 10-2 detects the abnormality of the communication state. In this way, it is possible to more accurately determine abnormality of a communication state.

In the aforementioned example of FIG. 3, a period corresponding to the cycle T after the frame f (A) is received in step S6 (for example, a period corresponding to a cycle set in a frame f which is an abnormal detection object) is an example of a “first predetermined period”. Furthermore, a period until the frame f (A) transmitted in step S5 is received after the start-up of the ECU 10-2 is an example of a “second predetermined period”. The “second predetermined period” is a period until the abnormality detection section 36 receives a predetermined signal and then receives the predetermined signal at the time of passage of a predetermined cycle. More specifically, the “second predetermined period” is a period until the abnormality detection section 36 receives two frames f (A) after the start-up. Furthermore, the second predetermined period is a period, in which a frame f (A) is excluded from determination regarding abnormality of a communication state even though the frame f (A), which is transmitted at a cycle different from the cycle T at which the frame f (A) is originally transmitted, is received. The post-start-up of the ECU 10-2 indicates a period after a return from a state in which the ECU 10-2 is not able to receive the frame f from the network, or a period after a return from a state in which the ECU 10-2 is not able to transmit the frame f to the network.

The aforementioned process has described that, after the ECU 10-2 starts to operate and receives the frame f (A), when the ECU 10-2 receives the frame f (A) before the cycle T passes, the ECU 10-2 does not determine abnormality of a communication state. However, when the frame f (A) is received before the passage of a predetermined cycle (for example, the shortest communication cycle to be described later) set in advance, the ECU 10-2 may not determine abnormality of a communication state.

[Process of Abnormality Detection Section]

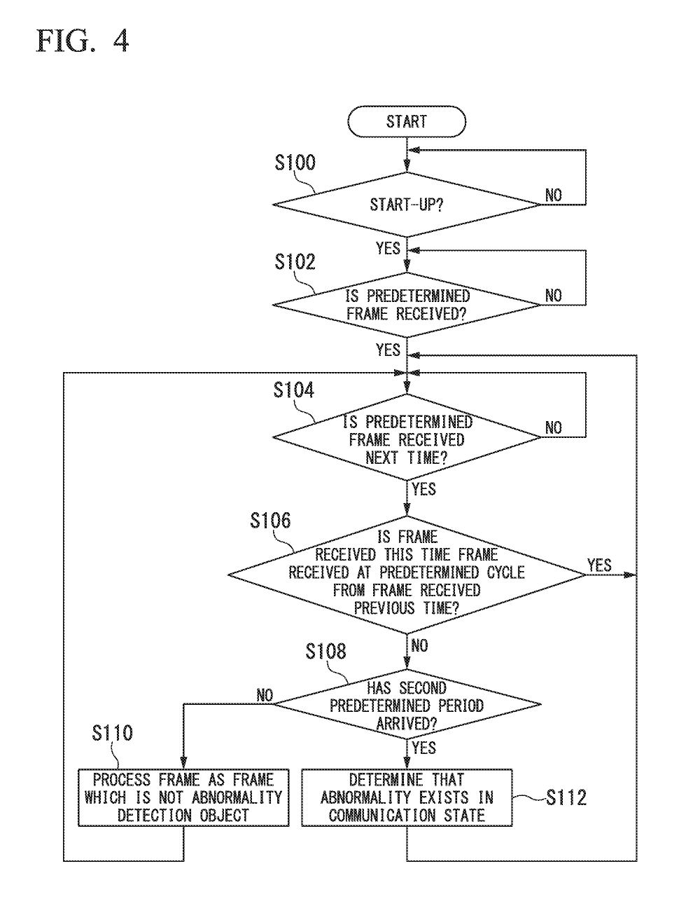

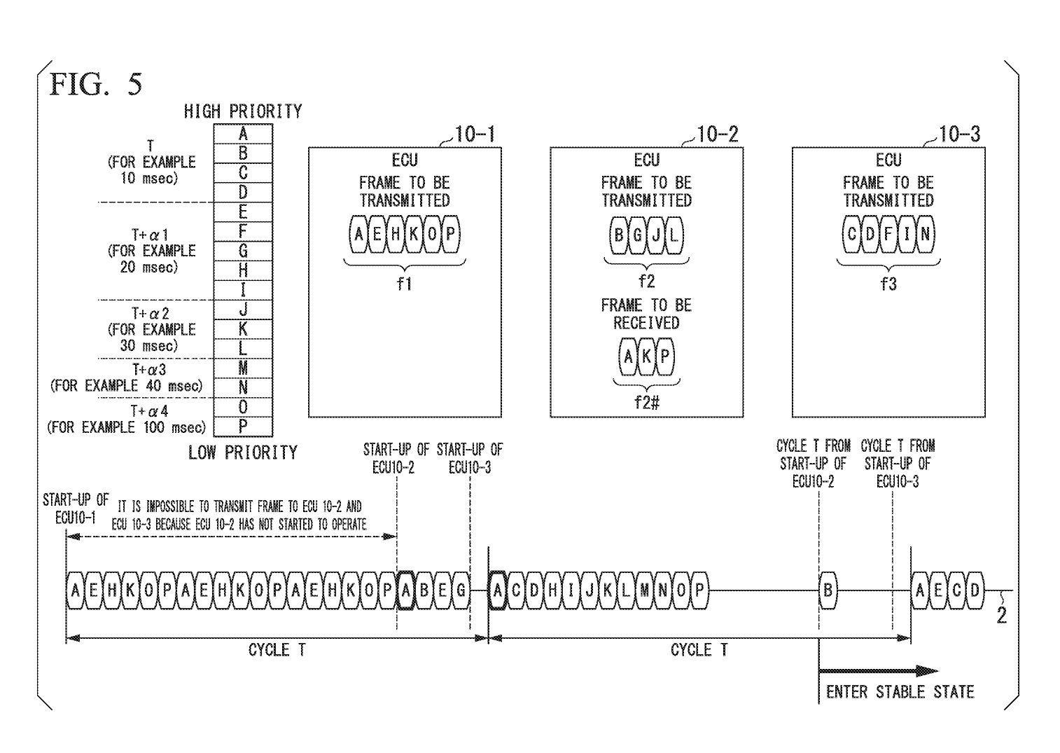

Details of the process of the ECU 10-2 will be described. FIG. 4 is a flowchart illustrating a flow of the process performed by the abnormality detection section 36 of the ECU 10-2. The present process may be applied to an apparatus which starts to operate with a delay after another apparatus (the ECU 10-1) starts to operate, in addition to the ECU 10-2.

Firstly, the ECU 10-2 waits for its own start-up (step S100). When the ECU 10-2 starts to operate, the abnormality detection section 36 waits until a predetermined frame f is received (step S102). When the predetermined frame f is received in step S102, the abnormality detection section 36 waits until the predetermined frame f is received next time (step S104).

When the predetermined frame f is received in step S104, the abnormality detection section 36 determines whether the frame f received this time in step S104 is a frame received at a predetermined cycle from the frame f received previous time (step S106). When the frame f is the frame f received at the predetermined cycle, the abnormality detection section 36 proceeds to the process of step S104.

When the frame f is not the frame f received at the predetermined cycle, the abnormality detection section 36 determines whether the second predetermined period is reached (step S108).

When the second predetermined period is not reached, the abnormality detection section 36 processes the frame received this time as a frame f which is not an abnormality detection object (step S110). When the second predetermined period is reached, the abnormality detection section 36 processes the frame received this time as a frame f which is the abnormality detection object, determines that an abnormality exists in a communication state (step S112) and returns to the process of step S104. In this way, processing of one routine of the present flowchart is ended.

When the abnormality exists in the communication state, the abnormality detection section 36 may allow an output unit to output information indicating the abnormality of the communication state. The output unit, for example, is a display unit, a speaker and the like installed at a vehicle. Furthermore, when it is determined that the abnormality exists in the communication state, the abnormality detection section 36 may perform a process of proceeding to a fail-safe mode. The fail-safe mode is control for stabilizing a behavior of a vehicle, control for safely stopping a vehicle, and the like.

Furthermore, the aforementioned flowchart of FIG. 4 illustrates an example in which when the frame f received this time is not the frame received at the predetermined cycle from the frame f received previous time in step S106, the process for determining whether the second predetermined period has reached is performed in step S108; however, the processing order is not limited to this example. For example, the processing order of step S106 and step S108 of the flowchart of FIG. 4 may be changed.

For example, when a predetermined frame is received at a next timing in step S104, the abnormality detection section 36 determines whether the second predetermined period is reached (step S106#).

When it is determined that the second predetermined period is reached, the abnormality detection section 36 determines whether the frame f received this time is the frame received at the predetermined cycle from the frame f received previous time (step S108#). When it is determined in step S108# that the frame f is not the frame received at the predetermined cycle from the frame f received previous time, the abnormality detection section 36 proceeds to the process of step S112, determines that abnormality exists in the communication state and ends the process of the present flowchart. When it is determined in step S108# that the frame f is the frame received at the predetermined cycle from the frame f received previous time, the abnormality detection section 36 proceeds to the process of step S104.

When the second predetermined period is not reached in step S106#, the abnormality detection section 36 may not perform the determination regarding whether the frame f received this time is the frame received at the predetermined cycle from the frame f received previous time in step S108#, and may proceed to the process of step S110 to process the frame received this time as the frame f which is not the abnormality detection object.

Furthermore, it is sufficient if the communication system 1 of the present embodiment includes the abnormality detection section 36 that detects abnormality of a communication state on the basis of the number of predetermined signals received in the first predetermined period or a predetermined period set in advance, and the abnormality detection method is not limited to the aforementioned method based on whether a received predetermined frame f is a frame f received at the predetermined cycle. For example, the predetermined period may be set, and the abnormality detection section 36 may count the number of predetermined frames f received during the predetermined period and detect abnormality on the basis of whether the count result is larger than a predetermined value. For example, when the count value exceeds the predetermined value, the abnormality detection section 36 determines that abnormality exists in the communication state. In this case, the predetermined frames f do not need to be transmitted every predetermined cycle.

[Specific Example of Process of Communication System]

Hereinafter, a specific example of the process performed by the ECUs 10-1 to 10-3 included in the communication system 1 will be described. FIG. 5 is a conceptual diagram of the process of the communication system. Firstly, an upper diagram of FIG. 5 will be described. The communication system 1 transmits/receives frames f (A) to (P). It is assumed that the frames f (A) to (P) are in order of priority. Transmission cycles are set for the frames f (A) to (P). The transmission cycle is shorter when the priority is higher.

For example, a cycle T (for example, 10 msec), the cycle T+α1 (for example, 20 msec), and the cycle T+α2 (for example, 30 msec) are set for the frames f (A) to (D), the frames f (E) to (I), and the frames f (J) to (L) in this order. Furthermore, it is assumed that the cycle T+α3 (for example, 40 msec) and the cycle T+α4 (for example, 100 msec) are set for the frames f (M) and (N), and the frames f (O) and (P), respectively.

Furthermore, it is assumed that frames fl allocated to be transmitted from the ECU 10-1 to an apparatus are the frames f (A), (E), (H), (K), (O), and (P), frames f2 allocated to be transmitted to the ECU 10-2 are the frames f (B), (G), (J), and (L), and frames f3 allocated to be transmitted to the ECU 10-3 are the frames f (C), (D), (F), (I), and (N). Furthermore, it is assumed that frames f2# allocated to be received in the ECU 10-2 are the frames f (A), (K), and (P). In the following description, it will be assumed that the aforementioned cycle T is a period equal to the shortest communication cycle at which the frames f1 to f3 can be transmitted. The shortest communication cycle is a period corresponding to a length obtained by adding a margin (a time margin) to the time required for transmitting/receiving the frames f transmitted/received in the communication system 1. Furthermore, it is assumed that the ECU 10-2 starts to operate after the ECU 10-1, and the ECU 10-3 starts to operate after the ECU 10-2 starts to operate and immediately before the cycle T passes after the ECU 10-1 transmits the frame f (A). Content similar to that described in the aforementioned FIG. 3 will not be described.

A lower diagram of FIG. 5 will be described. The lower diagram of FIG. 5 illustrates the frames f transmitted to the communication path 2. When the ECU 10-1 starts to operate, the ECU 10-1 repeatedly transmits the frames f1 until an ACK notification is transmitted from the ECU 10-2.

When the ECU 10-2 starts to operate, the ECU 10-2 receives the frame f (A) transmitted from the ECU 10-1 and transmits the frames f (B) and (G) to the communication path 2. After the ECU 10-2 starts to operate, the frames f1 and f2 are transmitted to the communication path 2 in accordance with priorities of the frames f1 and f2 to be transmitted from the ECUs 10-1 and 10-2.

Next, after the ECU 10-3 starts to operate, the ECU 10-1 transmits the frames f1 (including the frame f (A)) allocated to be transmitted on the basis of the transmission cycle of the frames f. The ECU 10-2 receives the frames f (A), (K), and (P) allocated to be received.

Furthermore, the ECU 10-2 transmits the frame f2, which has not been transmitted (has been stored in the transmission buffer), among the frames f2 allocated to be transmitted on the basis of the transmission cycle of the frames f. For example, the ECU 10-2 stores frames f allocated to be transmitted to the transmission buffer after its own start-up.

Then, when the ECU 10-2 starts to operate and then the cycle T passes from the transmission of the frame f (B), the ECU 10-2 transmits the frame f (B). Furthermore, when the cycle T passes from the transmission of the frame f (A), the ECU 10-1 transmits the frames f1 (including the frame f (A)). Furthermore, when the cycle T passes from the transmission of the frame f (C), the ECU 10-3 transmits the frame f (C). As described above, the frames f enter a state in which they are transmitted on the basis of the set cycles.

Hereinafter, the first predetermined period and the second predetermined period will be described with reference to FIG. 5. The first predetermined period is an arbitrary period after the second predetermined period. The second predetermined period is a period of the following (1) to (3). (1) A period until the ECU 10-2 starts to operate and then receives all frames f with IDs allocated to be received therein. In the example of FIG. 5, it is a period until the frame f2# is received. (2) A period until the ECU 10-2 starts to operate and then receives a frame f with an ID having the lowest priority among the IDs allocated to be received therein. In the example of FIG. 5, it is a period until the frame f (P) is received. (3) A period of a state in which the ECU 10-2 starts to operate and then a signal exceeding a predetermined amount is stored in the transmission buffer. In the example of FIG. 5, it is a period in which the frame f2 allocated to be transmitted is stored in the transmission buffer of the ECU 10-2 after the start-up. More specifically, it is a period until the ECU 10-2 starts to operate and then transmits the frame f (L).

Furthermore, an end point of the second predetermined period may be a period until the ECU 10-3 included in the communication system 1 starts to operate, the state, in which the frame f is received at a cycle different from the set cycles due to a difference among the start-up timings of the ECUs 10-1 to 10-3, is released and the communication system 1 enters a stable state. The period until the communication system 1 enters the stable state, for example, may be a period until the ECU 10-2 starts to operate and then an ACK notification is received for all frames transmitted from the ECU 10-2 to each ECU. In a specific example, it is assumed that the ECU 10-2 is set to transmit the frames f3 and f4 to the ECU 10-3 and the ECU 10-4, respectively after the ECU 10-2 starts to operate. In this case, it is a period until the ECU 10-2 reaches a state in which an ACK notification serving as a response from the ECU 10-3 to the frame f3 is received and an ACK notification serving as a response from the ECU 10-4 to the frame f4 is received (for example, a state in which the ECU 10-3 and the ECU 10-4 can transmit the ACK notifications serving as responses to the transmitted frames). Alternatively, it may be a period until a state, in which ACK notifications are received for all the transmitted frames, is continued over the predetermined cycle when the ECU 10-2 starts to operate and then transmits frames to each ECU every predetermined cycle.

As described above, after the ECU 10-2 starts to operate, even though the frame f (A) is received and then is received again before the passage of the cycle T set in advance for the frame f (A), the abnormality detection section 36 excludes the frame f (A) received again from an object determined as abnormality of a communication state, so that it is possible to accurately determine abnormality of a communication state.

According to the embodiment described above, by providing the communication unit 40, which is connected to the communication path, and the abnormality detection section 36, which detects abnormality of a network on the basis of the number of predetermined frames f received in the first predetermined period via the communication unit 40 and waits for a process of detecting the abnormality of the network in the second predetermined period after the start of communication in the network, it is possible to accurately determine abnormality of a communication state.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A communication apparatus comprising:
a communication unit configured to be connected to a communication path; and
an abnormality detection section configured to detect an abnormality in a network based on a number of predetermined signals received in a first predetermined period via the communication unit and to wait for a process of detecting the abnormality in the network in a second predetermined period after a start of a communication in the network.

2. The communication apparatus according to claim 1,
wherein the second predetermined period includes a period after a return from a state in which a signal is not receivable from the network.

3. The communication apparatus according to claim 1,
wherein the second predetermined period includes a period after a return from a state in which a signal is not transmittable to the network.

4. The communication apparatus according to claim 1, further comprising:
a storage area configured to store a signal to be transmitted,
wherein the second predetermined period includes a period after a start of a communication when the communication starts in a state in which a signal exceeding a predetermined amount is stored in the storage area.

5. The communication apparatus according to claim 1,
wherein the second predetermined period includes a period after an ignition is controlled from an OFF state to an ON state.

6. The communication apparatus according to claim 1,
wherein the second predetermined period is a period until the abnormality detection section receives the predetermined signal and then receives the predetermined signal when a predetermined cycle elapses.

7. The communication apparatus according to claim 1, further comprising:
an information storage unit configured to store identification information allocated to the communication apparatus,
wherein the second predetermined period is set as a period until the abnormality detection section receives all signals with the identification information allocated to the communication apparatus and stored in the information storage unit.

8. The communication apparatus according to claim 1, further comprising:
an information storage unit configured to store identification information having a lowest priority among identification information allocated to the communication apparatus,
wherein the second predetermined period is set as a period until the abnormality detection section receives a signal with the identification information having the lowest priority among the identification information allocated to the communication apparatus.

9. The communication apparatus according to claim 1,
wherein the second predetermined period is a period until, in a case where the communication apparatus transmits a signal to another communication apparatus, a response signal serving as a response from the other communication apparatus to the signal is received in the communication apparatus.

10. A communication apparatus comprising:
a communication unit configured to be connected to a communication path; and
an abnormality detection section configured to determine that an abnormality exists in a communication state when a signal is received at a timing different from a reception cycle set in advance for a signal received via the communication unit,
wherein after the communication apparatus starts a communication in a network and a first signal is received, when the first signal is received again before a reception cycle set in advance for the first signal elapses, the abnormality detection section excludes the first signal received again from an object determined as an abnormality in the communication state.

11. A communication method by way of a computer installed at a vehicle, the method comprising:
detecting an abnormality in a network based on a number of predetermined signals received in a first predetermined period; and
waiting for a process of detecting the abnormality in the network in a second predetermined period after a start of a communication in the network.

12. A computer readable non-transitory recording medium including a program causing a computer installed at a vehicle to perform:
detecting an abnormality in a network based on a number of predetermined signals received in a first predetermined period; and
waiting for a process of detecting the abnormality in the network in a second predetermined period after a start of a communication in the network.
